(19) United States
(12) Patent Application Publication
(10) Pub. No.: US 2006/0102280 A1
(43) Pub. Date: May 18, 2006

(54) Metallisied opaque film

(75) Inventors: Detlef Hutt, Heusweiler (DE); Yvonne Dupre, Kaiserslautern (DE); Karl-Heinz Kochem, Neunkirchen (DE)

Correspondence Address: CONNOLLY BOVE LODGE & HUTZ, LLP, P O BOX 2207, WILMINGTON, DE, 19899, US

(73) Assignee: TREOFAN GERMANY GMBH & CO. KG, NEUNKIRCHEN (DE)

(21) Appl. No.: 10/544,905

(22) PCT Filed: Feb. 20, 2004
(86) PCT No.: PCT/EP04/01680

§ 371 Date: Sep. 19, 2005

(30) Foreign Application Priority Data
Feb. 20, 2003 (DE) 103 07 133.4
Nov. 26, 2003 (DE) 103 55 231.6

(51) Int. Cl. B32B 15/08; B32B 27/32

(52) U.S. Cl. 156/325; 428/461; 428/910; 428/516; 428/523

(57) ABSTRACT

The invention relates to a metallised, biaxially orientated opaque polypropylene multi-layered film comprising a base layer and a first metallised cover layer and a second sealable cover layer on the opposite side. The first cover layer contains at least 80 wt. % of a propylene ethylene copolymer having an ethylene content of 1.2-<2.8 wt. % and a propylene content of 97.2 98.8 wt. % and a melting point ranging from 145-160° C. and a melting enthalpy of 80-110 J/g. The first cover layer has a thickness of at least 4 μm and the base layer is vacuolar. Said thick cover layer can also be made of a combination of an intermediate layer and a thin cover layer.

The present invention relates to a metallized opaque polypropylene film and a method for its manufacture.

Biaxially oriented polypropylene films (boPP) are currently used as packaging films in greatly varying applications. Polypropylene films are distinguished by many advantageous usage properties such as high transparency, gloss, barrier to water vapor, good printability, rigidity, piercing resistance, etc. In addition to the transparent films, opaque polypropylene films have been developed very successfully in past years. The special appearance (opacity and degree of whiteness) of these films is especially desirable for certain applications. In addition, opaque films offer a higher yield to the user because of the reduced density of these films.

In spite of these manifold favorable properties, there are still areas in which the polypropylene film must be combined with other materials in order to compensate for specific deficits. In particular for bulk products which are sensitive to moisture and oxygen, polypropylene films have not been successful until now as the sole packaging material. For example, in the field of snack packaging, both the water vapor barrier and also the oxygen barrier play a decisive role. With water absorption of only 3%, potato chips and other snack items become so sticky that the consumer finds them inedible. In addition, the oxygen barrier must ensure that the fats contained in the snack items do not develop a rancid taste through photooxidation. These requirements are not fulfilled by polypropylene film alone as the packaging material.

The barrier properties of polypropylene films having a vacuole-containing base layer are even more problematic, since in these types of films the vacuoles in the base layer additionally impair the water vapor barrier. For example, the water vapor barrier of a transparent biaxially oriented polypropylene film of 25 μm is approximately 4.4 g/m²*day at 38° C. A comparable value is only achieved in an opaque film having vacuole-containing base layer from a thickness of 35 μm. The oxygen barrier is completely insufficient for many applications both in transparent and in opaque polypropylene films.

Improving the barrier properties of boPP by metallization, by which both the water vapor permeability and also the oxygen permeability are significantly reduced, is known. Opaque films are typically not used in metallization, since their barrier is significantly worse without metallization than that of a transparent film. The barrier of the metallized films is better the better the barrier of the base film before the metallization is. For example, the oxygen permeability of a transparent 20 μm boPP film may be reduced through metallization and lamination with a further 20 μm transparent film to approximately 40 cm³/m²*day*bar (see VR Interpack 99 Special D28 “Der gewisse Knack [the special snap]”).

In some applications, the good barrier, as is known from transparent metallized films, is to be combined with the special opaque appearance of the vacuole-containing films, i.e., a metallized opaque barrier film is to be provided. In order to compensate for the known poor barrier starting values of opaque films, barrier coatings, made of PVOH, PVDC, or EVOH, for example, are applied before the metallization, in order to reduce the permeability of the substrate to be metallized. After metallization on the coating, outstanding barrier values may be achieved even in opaque films. However, these achievements of the object are very costly, since two costly finishing steps are necessary.

In some applications, boPP films are also metallized only in consideration of the visual impression. In this case, the impression of a high-quality package is to be given to the consumer, without a better barrier actually existing. In these cases, the requirements for the metallized film are comparatively non-critical. The metallized film must only have a uniform appearance and adequate metal adhesion. The barrier achieved plays no role and is only insignificantly better.

DE 39 33 695 describes a non-sealable film made of a base layer made of polypropylene and at least one covering layer, which is synthesized from a special ethylene-propylene copolymer. This copolymer is distinguished by an ethylene content of 1.2 to 2.8 weight-percent and a distribution factor of >10 and a melting enthalpy of >80 J/g and a melt flow index of 3 to 12 g/10 minutes (21.6 N and 230° C.). According to the description, the properties of the copolymer must be kept within these narrow limits to improve the printability and the visual properties. This publication relates overall to transparent films.

The present invention is based on the object of providing an opaque film having good barriers to oxygen and water vapor. Of course, the typical usage properties of the film in regard to its use as a packaging film must also otherwise be maintained, particularly sufficient bending strength, gloss, or low density.

The object on which the present invention is based is achieved by a metallized, biaxially oriented opaque polypropylene multilayered film having at least three layers comprising a vacuole-containing base layer and at least one intermediate layer and one covering layer, the first covering layer and the first intermediate layer lying one on top of another and the first intermediate layer containing propylene homopolymer and having a thickness of 4 to 10 μm and the first covering layer containing at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g, and the first covering layer having a thickness of 0.3-<4 μm and the film being metallized on the surface of the first covering layer.

As defined in the present invention, the base layer is the layer of the film which makes up more than 40%, preferably more than 50% of the total thickness of the film. Intermediate layers are layers which lie between the base layer and a further polyolefin layer. Covering layers form the external layers of the non-metallized coextruded film. The second optional covering layer may be applied directly to the base layer. Furthermore, there are embodiments in which both covering layers are applied to the intermediate layers of the film.

It was found that the film having an opaque base layer surprisingly has an outstanding barrier after the metallization if the covering layer to be metallized is applied to a propylene homopolymer intermediate layer and the intermediate layer has a thickness of 4 to 10 μm and the covering layer is synthesized from the propylene-ethylene copolymer having low ethylene content defined in greater detail in claim 1.

Surprisingly, layer thicknesses in the range from 0.3 to <4 μm are sufficient for the covering layer made of the special copolymer if a sufficiently thick homopolymer intermediate layer is additionally applied.

Surprisingly, this measure improves the barrier of the opaque film significantly after metallization, although no special barrier properties could be detected at the non-metallized opaque film and no other special measures, such as coatings, were used to improve the non-metallized substrate.

The films according to the present invention combine the desired opaque appearance of the vacuole-containing base layer with a very good barrier in relation to water vapor and oxygen after metallization. These film may therefore be used especially advantageously for manufacturing packages for bulk products sensitive to water vapor and oxygen.

The propylene copolymers used according to the present invention in the layer to be metallized, having a low ethylene content and a high melting point, are known per se and will also be referred to in the framework of the present invention as “minicopo” because of their comparatively low ethylene content. Thus, different teachings describe the advantageous use of these raw materials. For example, it is specified in EP 0 361 280 that this material is advantageous as a covering layer in films which may be metallized. DE 39 33 695 describes improved adhesion properties of these covering layers. However, it was neither known nor foreseeable that these special copolymers would have a favorable effect on the barrier properties after metallization as the covering layer of a film having a vacuole-containing base layer if an additional thick homopolymer intermediate layer is attached.

For the purposes of the present invention, propylene-ethylene copolymers having an ethylene content of 1.2 to 2.8 weight-percent, particularly 1.2 to 2.3 weight-percent, preferably 1.5 to <2 weight-percent, are especially preferred. The melting point is preferably in a range from 150 to 155° C. and the melting enthalpy is preferably in a range from 90 to 100 J/g. The melt flow index is generally 3 to 15 g/10 minutes, preferably 3 to 9 g/10 minutes (230° C., 21.6 N DIN 53 735). Furthermore, it is especially advantageous if a higher proportion of the ethylene units are incorporated into the propylene chain isolated between two propylene components. This characteristic may be described via a distribution factor, which is generally to be above 5, preferably above 10, particularly >15. The distribution factor is determined via ¹³C NMR spectroscopy, as described, for example, in DE 39 33 695 (page 2).

In general, the first covering layer contains at least 80 weight-percent, preferably 95 to 100 weight-percent, particularly 98 to <100 weight-percent of the described copolymers. In addition to this main component, the covering layer may contain typical additives such as antiblocking agents, stabilizers, and/or neutralization agents in the particular effective quantities. If necessary, small quantities of a second polyolefin different from the minicopo, preferably propylene polymers, may be contained if its proportion is below 20 weight-percent, preferably below 5 weight-percent, and the ability to metallize the layer is not impaired. Embodiments of this type are not preferred, but are conceivable if, for example, antiblocking agents are incorporated via concentrates which are based on a different polymer, such as propylene homopolymers or other propylene mixed polymers. In regard to the metallization, additives which impair the ability to be metallized should not be contained in the covering layer or should only be contained in the smallest quantities. This applies to migrating lubricants or antistatic agents, for example. The thickness of the first covering layer is in a range from 0.3-<4 μm, preferably 0.3 to 2 μm, particularly 0.5-1 μm.

To improve the metal adhesion, the surface of the first covering layer is generally subjected in a way known per se to a method for elevating the surface tension using corona, flame, or plasma. Typically, the surface tension of the covering layer thus treated, which has not yet been metallized, is in a range from 35 to 45 mN/m.

It is essential to the present invention that the first covering layer is applied to a first intermediate layer made of propylene homopolymer. This first intermediate layer generally contains at least 80 weight-percent, preferably 95 to 100 weight-percent, particularly 98 to <100 weight-percent propylene homopolymer. In addition to this main component, the first intermediate layer may contain typical additives such as stabilizers and/or neutralization agents, as well as possibly pigments, such as TiO₂, in the particular effective quantities. If necessary, small quantities of a second different propylene polymers may be contained if its proportion is below 20 weight-percent, preferably below 5 weight-percent, and the ability to metallize the layer is not impaired. Embodiments of this type are not preferred, but are conceivable if, for example, pigments are incorporated via concentrates which are based on a different polymer, such as propylene homopolymers or other propylene mixed polymers. In regard to the metallization, additives which impair the ability to be metallized should not be contained in the covering layer or should only be contained in the smallest quantities. This applies to migrating lubricants or antistatic agents, for example. The thickness of the first intermediate layer is in a range from 4 to 10 μm, preferably 5 to 8 μm according to the present invention.

The propylene homopolymer of the first intermediate layer comprises 100 weight-percent propylene units, extremely small quantities of comonomer from the polymerization process possibly being able to be present, which do not exceed a proportion of 1 weight-percent, preferably 0.5 weight-percent, however. The propylene homopolymer has a melting point of 155 to 165° C., preferably 160-162° C., and generally has a melt flow index of 1 to 10 g/10 minutes, preferably 2 to 8 g/10 minutes, at 230° C. and a force of 21.6 N (DIN 53735). The propylene polymers are isotactic propylene homopolymers having an atactic proportion of 15 weight-percent or less. The weight percents specified relate to the particular polymer.

Embodiments having a white first intermediate layer generally contain 2-15 weight-percent, preferably 3-10 weight-percent TiO₂. Suitable TiO₂ is described in detail in the following connection with the base layer. Pigmented intermediate layers of this type advantageously act as “visual” barriers and prevent the metal coating from showing through on the diametrically opposite opaque side of the film and provide the film on this opaque side with an advantageous white appearance.

The film according to the present invention is also distinguished by vacuoles in the base layer, which provide the film with an opaque appearance. “Opaque film” as defined in the present invention means an opaque film, whose light transmission (ASTM-D 1003-77) is at most 70%, preferably at most 50%.

The base layer of the multilayer film contains polyolefin, preferably a propylene polymer, and vacuole-initiating fillers, as well as further typical additives as necessary in the particular effective quantities. In general, the base layer contains at least 70 weight-percent, preferably 75 to 98 weight-percent, particularly 85 to 95 weight-percent of the polyolefin, in relation to the weight of the layer in each case. In a further embodiment, the base layer may additionally contain pigments, particularly TiO₂.

Propylene polymers are preferred as the polyolefins of the base layer. These propylene polymers contain 90 to 100 weight-percent, preferably 95 to 100 weight-percent, particularly 98 to 100 weight-percent propylene units and have a melting point of 120° C. or higher, preferably 150 to 170° C., and generally have a melt flow index of 1 to 10 g/10 minutes, preferably 2 to 8 g/10 minutes, at 230° C. and a force of 21.6 N (DIN 53735). Isotactic propylene homopolymers having an atactic proportion of 15 weight-percent or less, copolymers of ethylene and propylene having an ethylene content of 5 weight-percent or less, copolymers of propylenes with C₄-C₈ olefins having an olefin content of 5 weight-percent or less, terpolymers of propylene, ethylene, and butylene having an ethylene content of 10 weight-percent or less and having a butylene content of 15 weight-percent or less represent preferred propylene polymers for the base layer, isotactic propylene homopolymer being especially preferred. The weight-percents specified relate to the particular polymer.

Furthermore, a mixture of the cited propylene homopolymers and/or copolymers and/or terpolymers and other polyolefins, particularly made of monomers having 2 to 6 C atoms, is suitable, the mixture containing at least 50 weight-percent, particularly at least 75 weight-percent propylene polymer. Suitable other polyolefins in the polymer mixture are polyethylenes, particularly HDPE, MDPE, LDPE, VLDPE, and LLDPE, the proportion of these polyolefins not exceeding 15 weight-percent each, in relation to the polymer mixture.

The opaque base layer of the film generally contains vacuole-initiating fillers in a quantity of at most 30 weight-percent, preferably 2 to 25 weight-percent, particularly 2 to 15 weight-percent, in relation to the weight of the opaque base layer.

As defined in the present invention, vacuole-initiating fillers are solid particles which are incompatible with the polymer matrix and result in the formation of vacuole-like cavities when the film is stretched, the size, type, and number of the vacuoles being a function of the quantity and size of the solid particles and the stretching conditions such as the stretching ratio and stretching temperature. The vacuoles reduce the density and provide the films with a characteristic nacreous, opaque appearance, which arises due to light scattering at the boundaries “vacuole/polymer matrix”. The light scattering at the solid particles themselves generally contributes comparatively little to the opacity of the film. Typically, the vacuole-initiating fillers have a minimum size of 1 μm, in order to result in an effective, i.e., opaque-making quantity of vacuoles. In general, the average particle diameter of the particles is 1 to 6 μm, preferably 1 to 4 μm. The chemical character of the particles plays a subordinate role.

Typical vacuole-initiating fillers are inorganic and/or organic materials which are incompatible with polypropylene, such as aluminum oxide, aluminum sulfate, barium sulfate, calcium carbonate, magnesium carbonate, silicates such as aluminum silicate (kaolin clay) and magnesium silicate (talcum) and silicon dioxide, of which calcium carbonate and silicon dioxide are preferably used. The typically used polymers which are incompatible with the polymers of the base layer come into consideration as organic fillers, particularly copolymers of cyclic olefins (COC) as described in EP-A-0 623 463, polyesters, polystyrenes, polyamides, and halogenated organic polymers, with polyesters such as polybutylene terephthalate and cycloolefinic copolymers being preferred. Incompatible materials and/or incompatible polymers means, as defined in the present invention, that the material and/or the polymer exists in the film as separate particles and/or as a separate phase.

In a further embodiment, the base layer may additionally contain pigments, for example, in a quantity of 0.5 to 10 weight-percent, preferably 1 to 8 weight-percent, particularly 1 to 5 weight-percent. The specifications relate to the weight of the base layer.

As defined in the present invention, pigments are incompatible particles which essentially do not result in vacuole formation upon stretching of the film. The coloring effect of the pigments is caused by the particles themselves. The term “pigments” is generally connected to an average particle diameter in the range from 0.01 to at most 1 μm and includes both “white pigments”, which color the film white, and also “color pigments”, which provide the film with a colored or black color. In general, the average particle diameter of the pigments is in the range from 0.01 to 1 μm, preferably 0.01 to 0.7 μm, particularly 0.01 to 0.4 μm.

Typical pigments are materials such as aluminum oxide, aluminum sulfate, barium sulfate, calcium carbonate, magnesium carbonate, silicates such as aluminum silicate (kaolin clay) and magnesium silicate (talcum), silicon dioxide, and titanium dioxide, of which white pigments such as calcium carbonate, silicon dioxide, titanium dioxide, and barium sulfate are preferably used. Titanium dioxide is especially preferred. Various modifications and coatings of TiO₂ are known per se in the related art.

The density of the film is essentially determined by the density of the base layer. The density of the vacuole-containing base layer is generally reduced by the vacuoles, if larger quantities of TiO₂ do not compensate for the density-reducing effect of the vacuoles. In general, the density of the opaque base layer is in a range from 0.45-0.85 g/cm³. The density of the film may vary in a wide range for the white-opaque embodiments described and is generally in a range from 0.5 to 0.95 g/cm³, preferably 0.6 to 0.9 g/cm³. The density is elevated in principle by adding TiO₂, but simultaneously reduced by the vacuole-initiating fillers in the base layer. For a base layer which does not contain any density-elevating TiO₂, the density of the opaque base layer is preferably in a range from 0.45 to 0.75 g/cm³, while in contrast the range from 0.6 to 0.9 g/cm³ is preferred for the white-opaque base layer.

The total thickness of the film is generally in a range from 20 to 100 μm, preferably 25 to 60 μm, particularly 30 to 50 μm. The thickness of the base layer is correspondingly 10 to 50 μm, preferably 10 to 40 μm.

In a further preferred embodiment, the film includes even further layers, which are applied to the diametrically opposite side of the base layer. Through a second covering layer, four-layer films result. Embodiments which additionally have a second intermediate layer and a second covering layer applied thereto result in five-layer films. In these embodiments, the thickness of the second covering layer is generally 0.5-3 ρm, intermediate layers are in the range from 1 to 8 μm. Combinations made of intermediate layer and covering layer advantageously have a total thickness of 2 to 8 μm. Sealable layers are preferred as further layers, both layers which may be hot sealed and those which may be cold sealed being understood here. Cold seal coatings may also be applied directly to the surface of the base layer. In general, however, it is preferable to first cover the base layer with the polymer covering layer and apply the cold seal coating to this polymer covering layer.

The additional covering layer and intermediate layer generally contain at least 80 weight-percent, preferably 90 to <100 weight-percent olefinic polymers or mixtures thereof. Suitable polyolefins are, for example, polyethylenes, propylene copolymers, and/or propylene terpolymers, as well as the propylene homopolymers already described in connection with the base layer.

Suitable propylene copolymers or terpolymers are generally synthesized from at least 50 weight-percent propylene and ethylene and/or butylene units as the comonomers. Preferred mixed polymers are random ethylene-propylene copolymers having an ethylene content of 2 to 10 weight-percent, preferably 5 to 8 weight-percent, or random propylene-butylene-1 copolymers, having a butylene content of 4 to 25 weight-percent, preferably 10 to 20 weight-percent, each in relation to the total weight of the copolymers, or random ethylene-propylene-butylene-1 terpolymers, having an ethylene content of 1 to 10 weight-percent, preferably 2 to 6 weight-percent, and a butylene-1 content of 3 to 20 weight-percent, preferably 8 to 10 weight-percent, each in relation to the total weight of the terpolymers. These copolymers and terpolymers generally have a melt flow index of 3 to 15 g/10 minutes, preferably 3 to 9 g/10 minutes (230° C., 21.6 N DIN 53735) and a melting point of 70 to 145° C., preferably 90 to 140° C. (DSC).

Suitable polyethylenes are, for example, HDPE, MDPE, LDPE, VLDPE, and LLDPE, of which HDPE and MDPE types are especially preferred. The HDPE generally has an MFI (50 N/190° C.) of >0.1 to 50 g/10 minutes, preferably 0.6 to 20 g/10 minutes, measured according to DIN 53 735, and a coefficient of viscosity, measured according to DIN 53728, part 4, or ISO 1191, in the range from 100 to 450 cm³/g, preferably 120 to 280 cm³/g. The crystallinity is 35 to 80%, preferably 50 to 80%. The density, measured at 23° C. according to DIN 53 479, method A, or ISO 1183, is in the range from >0.94 to 0.96 g/cm³. The melting point, measured using DSC (maximum of the melting curve, heating speed 20° C./minute), is between 120 and 140° C. Suitable MDPE generally has an MFI (50 N/190° C.) of greater than 0.1 to 50 g/10 minutes, preferably 0.6 to 20 g/10 minutes, measured according to DIN 53 735. The density, measured at 23° C. according to DIN 53 479, method A, or ISO 1183, is in the range from >0.925 to 0.94 g/cm³. The melting point, measured using DSC (maximum of the melting curve, heating speed 20° C./minute), is between 115 and 130° C.

In regard to the appearance of this film side, embodiments having a propylene homopolymer intermediate layer and a sealable covering layer are preferred. In this case, the intermediate layer is synthesized from at least 80 weight-percent, preferably 85 to 98 weight-percent propylene homopolymer and has a thickness of at least 2 μm, preferably 2.5 to 6 μm. To improve the appearance, particularly the degree of whiteness, the pigments described above for the base layer are added to this intermediate layer, particularly TiO₂ in a quantity of 2 to 12 weight-percent, preferably 3 to 8 weight-percent, in relation to the weight of the intermediate layer.

In general, sealing layers are applied to intermediate layers colored white in this way in a thickness of 0.3 to 4 μm. Typical sealing layers made of propylene copolymers or propylene terpolymers come into consideration for this purpose. Suitable propylene copolymers or terpolymers are generally synthesized from at least 50 weight-percent propylene and ethylene and/or butylene units as the comonomers. Random ethylene-propylene copolymers having an ethylene content of 2 to 10 weight-percent, preferably 5 to 8 weight-percent, or random propylene-butylene-1 copolymers, having a butylene content of 4 to 25 weight-percent, preferably 10 to 20 weight-percent, each in relation to the total weight of the copolymers, or random ethylene-propylene-butylene-1 terpolymers, having an ethylene content of 1 to 10 weight-percent, preferably 2 to 6 weight-percent, and a butylene-1 content of 3 to 20 weight-percent, preferably 8 to 10 weight-percent, each in relation to the total weight of the terpolymers, are preferred. These copolymers and terpolymers generally have a melt flow index of 3 to 15 g/10 minutes, preferably 3 to 9 g/10 minutes (230° C., 21.6 N DIN 53735) and a melting point of 70 to 145° C., preferably 90 to 140° C. (DSC).

These embodiments are distinguished by an especially advantageous appearance on the side diametrically opposite the metal coating. The addition of titanium dioxide effectively prevents the metal coating from showing through, due to which this “opaque” side of the film appears grayish and impairs the white appearance.

If the film is used as a package for chocolate products, either the metallized side (after application of an adhesion promoter) or the surface of the “opaque side” is provided with a cold seal adhesive. In addition, the film may be used as a normal sealable film in which the manufacture of the package is performed via hot sealing.

If necessary, the film may also be used as a pouch package for powdered bulk products. For applications of this type, a mixture made of the described propylene copolymers and/or terpolymers and the cited polyethylenes is especially used for the second intermediate layer and, if necessary, for the second covering layer. These mixtures are especially advantageous in regard to the sealing properties of the film if the pouch is used for packaging powdered bulk products. Using the current methods for packaging powders, contamination of the seal regions may not be effectively prevented. These contaminations frequently result in problems during sealing. The seal seams have reduced or even no strength in the contaminated regions, and the tightness of the seal seam is also impaired. Surprisingly, the contaminations interfere only slightly or not at all during sealing if the seal layers are synthesized from a mixture of propylene polymers and polyethylenes. Covering layer mixtures which contain HDPE and/or MDPE, having an HDPE or MDPE proportion of 10 to 50 weight-percent, particularly 15 to 40 weight-percent, are especially advantageous for this purpose.

In a further application, the film according to the present invention may be processed into a laminate. For this purpose, the metallized side is preferably laminated against an opaque or transparent polypropylene or polyethylene film. This composite is preferably used for packaging fatty foods, e.g., dry powders or snacks.

As already noted, all layers of the film preferably contain neutralization agents and stabilizers in the particular effective quantities.

The typical stabilizing compounds for ethylene, propylene, and other olefin polymers may be used as stabilizers. The quantity added is between 0.05 and 2 weight-percent. Phenolic stabilizers, alkaline/alkaline earth stearates, and alkaline/alkaline earth carbonates are especially suitable. Phenolic stabilizers are preferred in a quantity of 0.1 to 0.6 weight-percent, particularly 0.15 to 0.3 weight-percent, and having a molar mass of more than 500 g/mol. Pentaerythrityl-tetrakis-3-(3,5-di-tertiary butyl-4-hydroxyphenyl)-propionate or 1,3,5-trimethyl-2,4,6-tris(3,5-di-tertiary butyl-4-hydroxybenzyl)benzene are especially advantageous.

Neutralization agents are preferably calcium stearate, and/or calcium carbonate and/or synthetic dihydrotalcite (SHYT) of an average particle size of at most 0.7 μm, an absolute particle size of less than 10 μm, and a specific surface area of at least 40 m²/g. In general, neutralization agents are used in a quantity of 50 to 1000 ppm, in relation to the layer.

In a preferred embodiment, antiblocking agents are added to both the covering layer to be metallized and also the diametrically opposite covering layer.

Suitable antiblocking agents are inorganic additives such as silicon dioxide, calcium carbonate, magnesium silicate, aluminum silicate, calcium phosphate, and the like, and/or incompatible polymers such as polymethyl methacrylate (PMMA) polyamides, polyesters, polycarbonates, with polymethyl methacrylate (PMMA), silicon dioxide, and carbon dioxide being preferred. The effective quantity of antiblocking agent is in the range from 0.1 to 2 weight-percent, preferably 0.1 to 0.5 weight-percent, in relation to the particular covering layer. The average particle size is between 1 and 6 μm, particularly 2 and 5 μm, particles having a spherical shape, as described in EP-A-0 236 945 and DE-A-38 01 535, being especially suitable.

Furthermore, the present invention relates to methods for manufacturing the multilayer film according to the present invention according to coextrusion methods known per se, the tentering method being particularly preferred.

In the course of this method, the melts corresponding to the individual layers of the film are coextruded through a sheet die, the film thus obtained is drawn off to solidify on one or more roll(s), the film is subsequently stretched (oriented), and the stretched film is thermally fixed and possibly plasma, corona, or flame treated on the surface layer provided for treatment.

Specifically, for this purpose, as is typical in the extrusion methods, the polymers and/or the polymer mixture of the individual layers is compressed in an extruder and liquefied, the vacuole-initiating fillers and other possibly added additives already being able to be contained in the polymer and/or in the polymer mixture. Alternatively, these additives may also be incorporated via a masterbatch.

The melts are then pressed jointly and simultaneously through a sheet die, and the multilayered film extruded is drawn off on one or more draw-off rolls at a temperature of 5 to 100° C., preferably 10 to 50° C., so that it cools and solidifies.

The film thus obtained is then stretched longitudinally and transversely to the extrusion direction, which results in orientation of the molecular chains. The longitudinal stretching is preferably performed at a temperature of 80 to 150° C., expediently with the aid of two rolls running at different speeds in accordance with the stretching ratio desired, and the transverse stretching is preferably performed at a temperature of 120 to 170° C. with the aid of a corresponding tenter frame. The longitudinal stretching ratios are in the range from 4 to 8, preferably 4.5 to 6. The transverse stretching ratios are the range from 5 to 10, preferably 7 to 9.

The stretching of the film is followed by its thermal fixing (heat treatment), the film being held approximately 0.1 to 10 seconds long at a temperature of 100 to 160° C. Subsequently, the film is wound up in a typical way using a winding device.

Preferably, after the biaxial stretching, one or both surfaces of the film is/are plasma, corona, or flame treated according to one of the known methods. The treatment intensity is generally in the range from 35 to 50 mN/m, preferably 37 to 45 mN/m, particularly 39 to 40 mN/m.

For the alternative corona treatment, the film is guided between two conductor elements used as electrodes, such a high voltage being applied between the electrodes, usually alternating voltage (approximately 10,000 V and 10,000 Hz), that spray or corona discharges may occur. Through the spray or corona discharge, the air above the film surface is ionized and reacts with the molecules of the film surface, so that polar intercalations arise in the essentially nonpolar polymer matrix. The treatment intensities are within the typical scope, 37 to 45 mN/m being preferred.

The coextruded multilayered film is provided on the outer surface of the first covering layer with a metal coating, preferably made of aluminum, according to methods known per se. This metallization is performed in a vacuum chamber in which aluminum is vaporized and deposited on the film surface. In a preferred embodiment, the surface to be metallized is subjected to plasma treatment directly before the metallization. The thickness of the metal coating generally correlates with the optical density of the metallized film, i.e., the thicker the metal coating is, the higher the optical density of the metallized film. In general, the optical density of the metallized film according to the present invention is to be at least 2, particularly 2.5 to 4.

The opaque film according to the present invention is distinguished by outstanding barrier values, which have not been implemented previously for opaque films. The water vapor permeability of the opaque metallized film according to the present invention is generally ≦0.5 g/m²*day at 38° C. and 90% relative ambient humidity, preferably in a range from 0.05 to 0.3 g/m²*day. The oxygen permeability is preferably ≦50 Cm³/m²*day*bar, preferably 5 to 30 cm³/m²*day*bar, particularly 5 to 25 cm³/m²*day*bar.

The following measurement methods were used to characterize the raw materials and the films:

Melt-Flow Index

The melt-flow index was measured according to DIN 53735 at 21.6 N load and 230° C.

Water Vapor and Oxygen Permeability

The water vapor permeability was determined in accordance with DIN 53122 part 2. The oxygen barrier effect was determined in accordance with the draft of DIN 53380 part 3 at an ambient humidity of approximately 50%.

Determination of the Ethylene Content

The ethylene content of the copolymer was determined using ¹³C NMR spectroscopy. The measurements were performed using an atomic resonance spectrometer from Bruker Avance 360. The copolymer to be characterized was dissolved in tetrachloroethane, so that a 10% mixture resulted. Octamethyl tetrasiloxane (OTMS) was added as a reference standard. The atomic resonance spectrum was measured at 120° C. The spectra were analyzed as described in J.C. Randall Polymer Sequence Distribution (Academic Press, New York, 1977).

Melting Point and Melting Enthalpy

The melting point and the melting enthalpy were determined using DSC (differential scanning calorimetry) measurement (DIN 51 007 and DIN 53 765). Several milligrams (3 to 5 mg) of the raw material to be characterized were heated in a differential calorimeter at a heating speed of 20° C. per minute. The thermal flux was plotted against the temperature and the melting point was determined as the maximum of the melting curve and the melting enthalpy was determined as the area of the particular melting peak.

Density

The density was determined according to DIN 53 479, method A.

Optical Density

The optical density is the measurement of the transmission of a defined light beam. The measurement was performed using a densitometer of the type TCX from Tobias Associates Inc. The optical density is a relative value which is specified without a dimension.

Surface Tension

The surface tension was determined via the ink method according to DIN 53364.

The present invention will now be explained through the following examples.

### EXAMPLE 1

A five-layer precursor film was extruded according to the coextrusion method from a sheet die at 240 to 270° C. This precursor film was first drawn off on a cooling roll and cooled. Subsequently, the precursor film was oriented in the longitudinal and transverse directions and finally fixed. The surface of the first covering layer was pretreated using corona to elevate the surface tension. The five-layer film had a layer structure of first covering layer/first intermediate layer/base layer/second intermediate layer/second covering layer. The individual layers of the film had the following composition:

First Covering Layer (0.5 μm):

˜100 weight-percent ethylene-propylene copolymer having an ethylene proportion of 1.7 weight-percent (in relation to the copolymer) and a melting point of 155° C.; and a melt flow index of 8.5 g/10 minutes at 230° C. and 2.16 kg load (DIN 53 735) and a melting enthalpy of 96.9 J/g

First Intermediate Layer (6.5 μm)

˜100 weight-percent propylene homopolymer (PP) having an n-heptane-soluble proportion of approximately 4 weight-percent (in relation to 100% PP) and a melting point of 163° C.; and a melt flow index of 3.3 g/10 minutes at 230° C. and 2.16 kg load (DIN 53 735)

Base Layer:

91.6 weight-percent propylene homopolymer (PP) having an n-heptane-soluble proportion of approximately 4 weight-percent (in relation to 100% PP) and a melting point of 163° C.; and a melt flow index of 3.3 g/10 minutes at 230° C. and 2.16 kg load (DIN 53 735) and 6.0 weight-percent calcium carbonate, average particle diameter approximately 2.7 μm 2.4 weight-percent titanium dioxide, average particle diameter of 0.1 to 0.3 μm

Second Intermediate Layer (3 μm)

96.4 weight-percent propylene homopolymer (PP) having an n-heptane-soluble proportion of approximately 4 weight-percent (in relation to 100% PP) and a melting point of 163° C.; and a melt flow index of 3.3 g/10 minutes at 230° C. and 2.16 kg load (DIN 53 735) and 3.6 weight-percent titanium dioxide, average particle diameter of 0.1 to 0.3 μm

Second Covering Layer (0.7 μm):

99.7 weight-percent ethylene-propylene copolymer having an ethylene proportion of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g

0.1 weight-percent antiblocking agent having an average particle diameter of approximately 4 μm (Sylobloc 45)

All layers of the film additionally contained stabilizers and neutralization agents in typical quantities.

Specifically, the following conditions and temperatures were selected when manufacturing the film:

| | |
|---|---|
| extrusion: | extrusion temperature approx. |
| | 250-270° C. |
| cooling roll: | temperature 30° C. |
| longitudinal stretching: | T = 120° C. |
| longitudinal stretching by a factor of 5 | |
| transverse stretching: | T = 160° C. |
| transverse stretching by a factor of 9 | |
| fixing: | T = 100° C. |

The film was surface treated on the surface of the first covering layer using corona and has a surface tension of 38 mN/m. The film has a thickness of 35 μm and an opaque appearance.

### EXAMPLE 2

A film was manufactured according to example 1. In contrast to example 1, the second intermediate layer contained no TiO₂. The compositions of the remaining layers and the manufacturing conditions were not changed.

### COMPARATIVE EXAMPLE 1

An opaque film was manufactured according to example 1. In contrast to example 1, the first intermediate layer was left out, i.e., the first covering layer was applied directly to the surface of the base layer.

### COMPARATIVE EXAMPLE 2

An opaque film was manufactured according to example 1. In contrast to example 1, a typical propylene copolymer was used in the first covering layer:

First Covering Layer (0.5 μm):

˜100 weight-percent ethylene-propylene copolymer having an ethylene proportion of 4 weight-percent (in relation to the copolymer) and a melting point of 136° C.; and a melt flow index of 7.3 g/10 minutes at 230° C. and 2.16 kg load (DIN 53 735) and a melting enthalpy of 64.7 J/g

### COMPARATIVE EXAMPLE 3

A film was manufactured as an example 2. In contrast to example 2, the base layer contained no vacuole-initiating fillers and no TiO₂ and the second intermediate layer also contained no TiO₂. A three-layer film resulted, since the intermediate layers and the base layer were only made of propylene homopolymer.

All films according to the examples and the comparative examples were coated with an aluminum coating in a vacuum metallizing facility. To improve the metal adhesion, the surface was subjected to a plasma treatment directly before the coating. The properties of the metallized films according to the examples in the comparative examples are summarized in Table 1. It has been shown that the films according to the present invention according to examples 1 and 2 have outstanding barrier values against water vapor and oxygen and, simultaneously, a good opaque and/or white appearance on the diametrically opposite side.

| | Thickness | Density of the | | WDD 38° C. 90% | OTR 23° C., 50% |
|---|---|---|---|---|---|
| Example | μm | film g/cm³ | Appearance | relative humidity*** | relative humidity*** |
| Example 1 | 35 | 0.71 | ++ | 0.15 | 9 |
| Example 2 | 35 | 0.71 | + | 0.14 | 10 |
| CE 1 | 35 | 0.71 | ++ | 0.5 | >100 |
| CE 2 | 35 | 0.71 | ++ | 0.5 | 135 |
| CE 3 | 35 | 0.91 | transparent | 0.3 | 30 |

*qualitative judgment of showing through of metal coating on the diametrically opposite side
***after metallization

1. A metallized, biaxially oriented opaque polypropylene multilayer film having at least three layers including a vacuole-containing base layer and at least one first intermediate layer and one first covering layer, characterized in that the first covering layer and the first intermediate layer lie one on top of another and the first intermediate layer contains propylene homopolymer and has a thickness of at least 4 to 10 μm and the first covering layer contains at least 80 weight-percent of a propylene-ethylene copolymer, which has an ethylene content of 1.2 to <2.8 weight-percent and a propylene content of 97.2-98.8 weight-percent and a melting point in the range from 145 to 160° C. and a melting enthalpy of 80 to 110 J/g and the first covering layer has a thickness of 0.3-<4 μm and the film is metallized on the surface of the first covering layer.

2. The film according to claim 1, characterized in that the propylene-ethylene copolymer contains 1.5 to 2.3 weight-percent ethylene and has a melting point in the range from 150 to 155° C. and a melting enthalpy of 90 to 100 J/g.

3. The film according to claim 1, characterized in that the first covering layer contains at least 80 weight-percent of the propylene-ethylene copolymer, in relation to the weight of the covering layer.

4. The film according to claim 1, characterized in that the first intermediate layer contains at least 80 weight-percent of a propylene homopolymer, which has a melting point of 160-162° C. and a melt flow index of 1 to 10 g/10 minutes.

5. The film according to claim 1, characterized in that the first intermediate layer contains 2 to 15 weight-percent TiO2.

6. The film according to claim 1, characterized in that the base layer is synthesized from propylene homopolymer and contains 2 to 1.5 weight-percent vacuole-initiating fillers.

7. The film according to claim 1, characterized in that the base layer contains 1 to 8 weight-percent TiO2.

8. The film according to claim 1, characterized in that the base layer has a density of 0.45-0.85 cm³/g.

9. The film according to claim 1, characterized in that the film has a second covering layer.

10. The film according to claim 9, characterized in that the second covering layer contains at least 80 to <100 weight-percent of a propylene polymer having at least 80 weight-percent propylene units.

11. The film according to claim 10, characterized in that the propylene polymer is a propylene copolymer and/or propylene terpolymer having a propylene content of at least 90 to 97 weight-percent.

12. The film according to claim 9, characterized in that the second covering layer is sealable and has a thickness of 0.3 to 4 μm.

13. The film according to claim 9, characterized in that a second intermediate layer is attached between the base layer and the second covering layer.

14. The film according to claim 13, characterized in that the second intermediate layer has 80 to <100 weight-percent propylene homopolymer.

15. The film according to claim 14, characterized in that the second intermediate layer contains 2 to 12 weight-percent TiO2.

16. A method for manufacturing a package which comprises sealing the film according to claim 11 at a temperature of at least 120°.

17. The method of manufacturing a package which comprises applying a cold seal coating to at least one surface of the film as claimed in claim 1 and the film is sealed at room temperature.

18. The film according to claim 9, characterized in that the second covering layer contains at least 80 to <100 weight-percent of a polymer mixture, the mixture comprising propylene polymers having at least 80 weight-percent propylene units and polyethylene and the mixture containing 10 to 50 weight-percent of the polyethylene in relation to the weight of the mixture.

19. The film according to claim 18, characterized in that the polyethylene is an HDPE or MDPE.

20. A package which comprises the film according to claim 18 and contains a powdered bulk product.

21. (canceled)

22. A method for manufacturing the film according to claim 1 which comprises coextruding the polyolefinic layers.

23. The method according to claim 22, characterized in that the film is pretreated on the surface of the first covering layer during the film manufacture using corona, plasma, or flame.

24. The method according to claim 23, characterized in that the surface to be metallized is treated directly before the metallization using plasma.

25. A process for manufacturing a laminate which comprises laminating the metallized side of the film according to claim 1 against a further polypropylene film or against a polyethylene film.
